(19) United States
(12) Patent Application Publication
(10) Pub. No.: US 2006/0020101 A1
(43) Pub. Date: Jan. 26, 2006

(54) Low-viscosity polyurethane prepolymers based on 2,4'-MDI

(75) Inventors: Matthias Wintermantel, Koln (DE); Walter Meckel, Dusseldorf (DE); Mathias Matner, Neuss (DE); Harald Kraus, Leverkusen (DE); Frank Kobelka, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/184,108

(22) Filed: Jul. 19, 2005

(30) Foreign Application Priority Data
Jul. 23, 2004 (DE) 102004035764.1

(51) Int. Cl. C08G 18/00

(52) U.S. Cl. 528/44

(57) ABSTRACT

The present invention relates to low-viscosity polyurethane prepolymers (PU prepolymers) based on 2,4′-MDI, to a process for preparing them and to their use.

### CROSS-REFERENCE TO RELATED APPLICATION

This application claims priority under 35 U.S.C. §119 to German application De 0 2004 035 764, filed Jul. 23, 2004.

### FIELD OF THE INVENTION

The present invention relates to low-viscosity, low-monomer-content, moisture-curing sealants based on 2,4′-MDI prepolymers, to a process for preparing them and to their use. Moisture-curing sealants based on polyurethane contain, besides fillers, pigments and flow assistants, essentially NCO-containing polyurethane prepolymers which crosslink by reaction with moisture via urea groups.

### BACKGROUND

Of particular interest nowadays are prepolymers which have an extremely low inherent viscosity. This makes it possible, during preparation, further processing and/or application of the PU systems, wholly or partly to dispense with the addition of viscosity-lowering additives such as solvents, thereby making it possible to avoid high VOC levels or disadvantageous material properties caused by additive residues in the polyurethane. Irrespective of the viscosity, a low residual amount of monomeric di- or triisocyanates in prepolymers and PU systems based thereon is desirable generally on occupational hygiene grounds.

In view of their outstanding properties, flexible, moisture-curing sealants on a polyurethane basis are of great importance for applications in the automotive sector and also in the construction sector.

EP-B 0 425 694 describes moisture-curing sealants comprising polyether-based PU prepolymers. Generally, aliphatic, cycloaliphatic and aromatic polyisocyanates are listed as an isocyanate building block for these prepolymers, although only tolylene diisocyanate is explicitly mentioned and used in the working examples. In view of the relatively high vapour pressure of monomeric TDI (2,4-TDI: 1,3·10⁻² mbar at 20° C.; 2,6-TDI 2.0·10⁻² mbar at 20° C.) it must be removed thoroughly following prepolymer preparation. This step is unwanted for reasons of cost. Consequently attempts are being made increasingly to replace TDI-based systems by their MDI-based counterparts. As well as the lower MDI vapour pressure, of 4.0·10⁻⁶ mbar at 20° C., the said counterparts have the advantage of a much faster cure rate.

In terms of the viscosity, however, the 4,4′-MDI-based prepolymers known from the prior art have disadvantages as compared with TDI systems of analogous construction. Thus an MDI-based prepolymer containing 98% by weight 4,4′-MDI has a viscosity of 70 000 mPa.s at 23° C. whereas a comparable TDI-based prepolymer has a viscosity of only 11 000 mPa.s at 23° C. While an increase in the 2,4′-MDI fraction to 25% by weight has no significant influence on viscosity and breaking elongation, there is a deterioration in tensile strength, stress value (100% modulus) and Shore A hardness (Lay et al., Polyurethane World Congr. Proc., 1991, page 319 ff).

EP-A 0 693 511 describes NCO-containing hotmelt systems prepared using MDI with a 2,4′ isomer fraction of at least 70% by weight, preferably at least 85% by weight. As a hydroxyl component it is possible, in addition to i) polyols containing ester and/or ether groups and having an average functionality of 1.95-2.2, to use polyols of higher functionality as well. It is preferred to use ester-functional polyols in i). Groups of that kind, however, are unstable to hydrolysis, and so are not suitable for use in the sealant sector. Known from WO 93/09158 are prepolymers which as isocyanate component preferably contain 2,4-TDI, MDI with at least 90% by weight 2,4′-MDI and/or IPDI. The polyol component used for the synthesis has a functionality of 2.05-2.5 and is composed of polyesters, polyethers and/or polyether esters having molecular weights of 200-6000 g/mol. The examples disclose prepolymers synthesized from an MDI containing more than 92% by weight 2,4′-MDI and from polyether-based diols and triols having molecular weights ≦1000 g/mol. Because of the relatively short-chain polyethers, pre-polymers of this kind are not suited to use for preparing elastic sealants from one-component, moisture-curing formulations.

WO 03/006521 and WO 03/033562 disclose low-monomer-content, NCO-containing prepolymers based on MDI, with 2,4′-MDI fractions of more than 97.5% by weight. Polyols used include polyether diols having molecular weights ≦2000 g/mol. Because of the relatively short-chain polyols, the prepolymer products obtained are solid or of extremely high viscosity at room temperature (shear viscosities at 23° C. of >100 000 mPa.s) and therefore are not readily amenable to use in low-solvent sealants which can be applied at room temperature.

WO 03/055929 describes NCO-containing prepolymers which are obtained preferably from 2,4′-MDI with 4,4′- and 2,2′-MDI fractions of preferably less than 1% by weight, and from polyols. Suitable polyols used are preferably at room temperature liquid or amorphous or crystalline compounds which have 2 or 3 OH groups per molecule and have average molecular weights of 400-20 000 g/mol. In this context, unspecific lists recite numerous polyether, polyester and polyacrylate polyols. From these prepolymers it is possible, among other formulations, to prepare one- and two-component adhesives/sealants. For that purpose they are used as a mixture with high molecular weight polyisocyanates. These high molecular weight polyisocyanates are likewise based on 2,4′-MDI but contain polyols having molecular weights of 60-2000 g/mol. Low-monomer-content sealants of low viscosity which cure on exposure to moisture and contain exclusively 2,4′-MDI prepolymers based on polyether diols having number-average molecular weights >2000 g/mol are not described.

WO 03/051951 discloses a process in which first of all an asymmetric diisocyanate is reacted with a polyol having an average molecular weight of 60-3000 g/mol to give an NCO-functional prepolymer, which is subsequently reacted with at least one further polyol. For the prepolymer preparation it is preferred to use TDI, IPDI or 2,4′-MDI. First-stage polyols which can be used include not only low molecular weight alcohols having 2-4 OH groups but also polyether, polyester or polyacrylate polyols. Prepolymers or sealants based exclusively on polyether polyols having number-average molecular weights ≧2000 g/mol and MDI with a 2,4′-MDI fraction of more than 95% by weight are not described.

### SUMMARY OF THE INVENTION

It has now surprisingly been found that for preparing moisture-curing sealants having breaking elongations in the cured sealant state according to DIN 53 504 of >100% it is possible to use suitable MDI-based prepolymers free from carboxylic ester groups, having shear viscosities of <100 000 mPa.s at 23° C., when the prepolymer is prepared using as isocyanate an MDI grade containing at least 95% by weight of 2,4′-MDI and as polyol a polyether polyol mixture which is composed of at least one polyether polyol with a number-average molecular weight Mₙ of 2000 g/mol to 20000 g/mol and with an average OH functionality of 3 to 8 and if desired, further polyether polyols, especially difunctional polyether polyols, having number-average molecular weights of more than 2000 g/mol and which in terms of composition is such as to give a total functionality, based on OH groups, of >2 and a number-average molecular weight Mₙ of 3000 to 20000 g/mol.

Prepolymers of this kind and moisture-curing sealants of this kind which include such prepolymers have not hitherto been described in the prior art.

The moisture-curing sealants based on them have a profile of properties which is comparable or improved as compared with prior art TDI-based systems.

The invention accordingly provides a process for preparing MDI-based prepolymers which are free of carboxylic ester groups and have shear viscosities of <100 000 mPa.s at 23° C., wherein an

A) isocyanate which is an MDI type containing at least 95% by weight of 2,4′-MDI is reacted with

B) a polyether polyol mixture composed of
b1) at least one polyether polyol with a number-average molecular weight Mₙ of 2000 to 20000 g/mol and an average OH functionality of 3 to 8 and
b2) if desired, further polyether polyols having number-average molecular weights of more than 2000 g/mol
   and wherein the fraction of b1) in B) is at least 20% by weight and B) is composed of b1) and b2) in such a way as to result in an overall functionality, relative to OH groups, of >2 and a number-average molecular weight Mₙ of from 3000 to 20000 g/mol.

Likewise provided by this invention are the prepolymers obtainable by the process and also the sealants and/or adhesives produced from them, with elongations at break according to DIN 53 504 of >100%.

### DETAILED DESCRIPTION OF PREFERRED EMBODIMENTS

As used herein, the abbreviation “MDI” means diphenylmethane diisocyanate.

The invention provides a process for preparing MDI-based prepolymers which are free of carboxylic ester groups and have shear viscosities of <100 000 mPa.s at 23° C., wherein an

A) isocyanate which is an MDI type containing at least 95% by weight of 2,4′-MDI is reacted with

B) a polyether polyol mixture composed of
b1) at least one polyether polyol with a number-average molecular weight Mₙ of 2000 to 20000 g/mol and an average OH functionality of 3 to 8 and
b2) if desired, further polyether polyols having number-average molecular weights of more than 2000 g/mol
   and wherein the fraction of b1) in B) is at least 20% by weight and B) is composed of b1) and b2) in such a way as to result in an overall functionality, relative to OH groups, of >2 and a number-average molecular weight Mₙ of from 3000 to 20000 g/mol.

Likewise provided by this invention are the prepolymers obtainable by the process and also the sealants and/or adhesives produced from them, with elongations at break according to DIN 53 504 of >100%.

The ratio of components A) and B) with respect to one another is preferably such that the NCO/OH ratio is below 2.0, more preferably 1.4-1.9.

The ratio of components A) and B) to one another is preferably such that the resulting prepolymers have an NCO content of less than 4% by weight.

The MDI type used as isocyanate in A) preferably has a 2,4′-MDI content of at least 97% by weight, more preferably at least 97.5% by weight.

The MDI grade isocyanate used in A) preferably has a 2,2′-MDI content of not more than 0.5% by weight, more preferably not more than 0.25% by weight.

Methylene diisocyanates of this kind containing 95% by weight or more of 2,4′-MDI are typically obtained by distillation or crystallization from the two-ring fraction of the MDI prepared industrially.

The polyether polyols used in B) are known per se to the skilled worker in polyurethane chemistry. They are typically obtained starting from low molecular weight, polyfunctional OH— or NH-functional compounds as starters by reaction with cyclic ethers or mixtures of different cyclic ethers. Catalysts used include bases such as KOH or double metal cyanide-based systems. Preparation processes suitable for this purpose are known to the skilled worker from, for example, U.S. Pat. No. 6,486,361 or L. E. St. Pierre, Polyethers Part I, Polyalkylene Oxide and other Polyethers, Editor: Norman G. Gaylord; High Polymers Vol. XIII; Interscience Publishers; Newark 1963; p. 130 ff.

Suitable starters have preferably 2-8, more preferably 2-6, hydrogen atoms capable of polyaddition with cyclic ethers. Examples of such compounds include water, ethylene glycol, 1,2- or 1,3-propylene glycol, 1,3-butanediol, 1,4-butanediol, 1,6-hexanediol, bisphenol-A, neopentyl glycol, glycerol, trimethylolpropane, pentaerythritol and sorbitol. Suitable cyclic ethers include alkylene oxides such as ethylene oxide, propylene oxide or butylene oxide, epichlorohydrin or styrene oxide or tetrahydrofuran.

In B) it is preferred to use polyethers based on aforementioned starters and containing propylene oxide, ethylene oxide and/or tetrahydrofuran units, preferably containing propylene oxide and/or ethylene oxide units.

The polyether polyols of component b1) preferably have number-average molecular weights of 2000 to 15000 g/mol. The preferred average OH functionality is 3-6, more preferably 3-4.

The polyether polyols of component b2) preferably have number-average molecular weights of 2000 to 25000 g/mol and more preferably 2000 to 18000 g/mol. The preferred average OH functionality is 2 to 6, more preferably 2 to 4, very preferably 2.

The ethylene oxide fraction of the polyether polyol of components b1) and b2) amounts to 0% to 25% by weight, preferably 0% to 20% by weight and more preferably 0% to 15% by weight.

The fraction of component b1) in the polyether polyol mixture B) is preferably at least 30% by weight.

The polyurethane prepolymers containing NCO end groups are prepared in a way which is known from polyurethane chemistry.

The preparation takes place preferably in a one-stage process. In that case the polyols of component B) are mixed, individually or as a mixture, with an excess of the isocyanate component A) and the homogeneous mixture is stirred until the NCO value is constant. The reaction temperature chosen is 50° C. to 120° C., preferably 50° C. to 100° C. Preferably both reactants and the reaction product are liquid at the chosen reaction temperature, so that it is possible to dispense with the use of additional solvents for homogenizing and lowering the viscosity of the reaction mixture.

The preparation can alternatively take place in a two-stage operation. In that case a precursor is prepared in a first step from b1) and/or b2) of component B) and an excess of the isocyanate component A). The reactants are stirred in a homogeneous mixture until a constant NCO value is obtained, at a temperature of 50° C. to 120° C., preferably at a temperature of 50° C. to 100° C. This precursor has a high unreacted monomeric diisocyanate content. This precursor is then reacted in a second reaction step with the remaining polyols of component B) to give the finished sealant prepolymer. The reactants are stirred in homogeneous mixture until a constant NCO value is obtained, at a temperature of 50° C. to 120° C., preferably at a temperature of 50° C. to 100° C. Preferably the reactants and the reaction products of the two stages are liquid at the reaction temperatures chosen, so that it is possible to do without the use of additional solvents for homogenizing and lowering the viscosity of the reaction mixtures.

Of course it is also possible for the polyurethane prepolymers containing NCO end groups to be prepared continuously in a stirred tank cascade or in suitable mixing equipment, such as high-speed mixers operating on the rotor/stator principle, for example. The NCO content is determined in accordance with an NCO-titrimetric process which is customary in polyurethane chemistry.

Where appropriate it is possible if desired to add catalysts for accelerating the NCO/OH reaction, and/or solvents, during the preparation of the prepolymer.

Suitable catalysts are the aminic compounds or organometallic compounds known per se from polyurethane chemistry.

By way of example it is possible to use the following compounds as catalysts: triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- and N-ethylmorpholine, N,N′-dimorpholinodiethyl ether (DMDEE), N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, N-hydroxypropylimidazole, 1-azabicyclo[2.2.0]octane, 1,4-diazabicyclo[2.2.2]octane (Dabco) and alkanolamine compounds, such as triethanolamine, triisopropanolamine, N-methyl- and N-ethyldiethanolamine, dimethylaminoethanol, 2(N,N-dimethylaminoethoxy)ethanol, N,N′,N-tri(dialkylaminoalkyl)hexahydrotriazines, e.g. N,N′,N-tris(dimethylaminopropyl)-s-hexahydrotriazine, iron(II) chloride zinc chloride, lead octoate and, preferably, tin salts, such as tin dioctoate, tin diethylhexoate, dibuthyltin dilaurate and/or dibutyldilauryltin mercaptide, 2,3-dimethyl-3,4,5,6-tetrahydropyrimidine, tetraalkylammonium hydroxides, such as tetramethylammonium hydroxide, alkali metal hydroxides, such as sodium hydroxide, alkali metal alkoxides, such as sodium methoxide and potassium isopropoxide, and/or alkali metal salts of long-chain fatty acids having 10 to 20 carbon atoms and, optionally, pendant OH groups. Further compounds which have been found suitable for use as catalysts include Ti compounds, especially Ti(IV)-O-alkyl compounds, with alkyl groups such as methyl, ethyl, n-propyl, isopropyl, n-butyl, isobutyl, tert-butyl, n-penty, 2-pentyl, 3-pentyl, preferably ethyl, n-propyl, isopropyl, n-butyl, isobutyl, tert-butyl and with particular preference Ti(IV) butoxide.

Likewise suitable, for example, are the organometallic compounds of tin, of lead, or iron, of titanium, of bismuth or of zirconium, such as tetraisopropyl titanate, lead phenylethyldithiocarbamate, tin(II) salts of carboxylic acids, such as tin(II) acetate, ethylhexoate and diethylhexoate, for example. A further class of compound is represented by the dialkyltin(IV) carboxylates. The carboxylic acids have 2, preferably at least 10, in particular 14 to 32 carbon atoms. Dicarboxylic acids can also be used. Specific acids that may be mentioned include the following: adipic acid, maleic acid, fumaric acid, malonic acid, succinic acid, pimelic acid, terephthalic acid, phenylacetic acid, benzoic acid, acetic acid, propionic acid and also 2-ethylhexanoic, caprylic, capric, lauric, myristic, palmitic and stearic acid.

Additionally tin oxides and tin sulphides and also tin thiolates can be used. Specific compounds include the following: bis(tributyltin)oxide, bis(trioctyltin)oxide, dibutyltin and dioctyltin bis(2-ethylhexyl thiolate), dibutyltin and dioctyltin didodecylthiolate, bis(β-methoxycarbonylethyl)tin didodecylthiolate, bis(β-acetylethyl)tin bis(2-ethylhexylthiolate), dibutyltin and dioctyltin didodecylthiolate, butyltin and octyltin tris(thioglycolic acid-2-ethylhexoate), dibutyl- and dioctyltin-bis(thioglycolic acid 2-ethylhexoate), tributyl- and trioctyltin(thioglycolic acid 2-ethylhexoate) and also butyltin and octyltin tris(thioethylene glycol 2-ethylhexoate), dibutyltin and dioctyltin bis(thioethylene glycol-2-ethylhexoate), tributyltin and trioctyltin (thioethylene glycol 2-ethylhexoate) with the general formula Rₙ₊₁Sn(SCH₂CH₂OCOC₈H₁₇)₃₋ₙ, where R is an alkyl group having 4 to 8 carbon atoms, bis(β-methoxycarbonylethyl)tin bis(thioethylene glycol 2-ethylhexoate), bis(β-methoxycarbonylethyl)tin bis(thioglycolic acid 2-ethylhexoate), and bis(β-acetylethyl)tin bis(thioethylene glycol 2-ethylhexoate) and bis(β-acetylethyl)tin bis(thioglycolic acid 2-ethylhexoate.

Organobismuth compounds used are, in particular, bismuth carboxylates, the carboxylic acids possessing 2 to 20 carbon atoms, preferably 4 to 14 atoms. Acids that may be mentioned explicitly include the following: butyric acid, caproic acid, caprylic acid, capric acid, lauric acid, myristic acid, palmitic acid, stearic acid, arachidic acid, isobutyric acid and 2-ethylhexanoic acid. It is also possible to use mixtures of bismuth carboxylates with other metal carboxylates, tin carboxylates for example.

It is preferred to use catalysts when preparing the prepolymers essential to the invention, and particular preference is given to using organometallic compounds. Through the use of such catalysts it is possible to prepare prepolymers having a particularly low residual free MDI monomer content in conjunction with low viscosity.

If catalysts are used their amount, relative to the total amount of the components A) and B) to be reacted, is 0.01% to 8% by weight, preferably 0.1% to 5% by weight. Preferred organometallic catalysts are those from the group of the tin(IV) compounds. Preferred catalysts from the group of the tin(IV) compounds are dibutyltin and dioctyltin diacetate, maleate, bis(2-ethylhexoate), dilaurate, dichloride, bisdodecylmercaptide, tributyltin acetate, bis(β-methoxycarbonylethyl)tin dilaurate and bis(β-acetylethyl)tin dilaurate.

A very particularly preferred organometallic catalyst is dibutyltin dilaurate. To terminate the reaction it is possible where appropriate to add an organic or inorganic acid such as hydrochloric acid, sulphuric acid, phosphoric acid or derivatives thereof, formic acid, acetic acid or another alkanoic or organic acid or an acid-releasing component, such as acid halides, for instance. Examples of suitable acid chlorides are formyl chloride, acetyl chloride, propionyl chloride and benzoyl chloride. It is particularly advantageous to terminate the reaction when one of the abovementioned known aminic or organometallic catalysts has been used during the preparation of the prepolymer.

Preference is given to using benzoyl chloride as terminator.

The products obtainable in accordance with the invention preferably have residual methylenediphenyl diisocyanate contents of less than 0.3% by weight, more preferably less than 0.15% by weight, based on the solvent-free NCO-functional prepolymer. The prepolymers obtainable in accordance with the invention have shear viscosities in solvent-free form, measured at 23° C., of preferably 5000-80000 mPa.s, more preferably 5000-70000 mPa.s.

The invention further provides polyurethane polymers, coatings, adhesive bonds and/or seals produced using the prepolymers obtainable in accordance with the invention, preference being given to moisture-curing sealants and/or adhesives based on the prepolymers essential to the invention.

The moisture-cured sealants and/or adhesives obtainable from them typically have breaking elongations in accordance with DIN 53 504 of >100%, preferably >200%, more preferably >300%.

To prepare such moisture-curing sealants and/or adhesives the NCO-containing polyurethane prepolymers of the invention can be formulated together with customary plasticizers, fillers, pigments, driers, additives, light stabilizers, antioxidants, thixotropic agents, catalysts, adhesion promoters and, where appropriate, further auxiliaries and additives in accordance with known methods of producing sealants.

Suitable fillers that may be mentioned include, by way of example, carbon black, precipitated silicas, pyrogenic silicas, mineral chalks and precipitated chalks.

Suitable plasticizers that may be mentioned include, by way of example, phthalates, adipates, alkylsulphonic esters of phenol, or phosphoric esters.

Examples of suitable thixotropic agents include pyrogenic silicas, polyamides, hydrogenated castor oil follow-on products or else polyvinyl chloride.

Examples of suitable catalysts for accelerating the cure include tertiary amines which are not incorporated into the prepolymer chain, such as diazabicyclooctane (Dabco), triethylamine, dimethylbenzylamine (Desmorapid® DB, Bayer MaterialScience AG, Leverkusen, DE), bisdimethylaminoethyl ether, tetramethylguanidine, bisdimethylaminomethylphenol, 2,2′-dimorpholinodiethyl ether, 2-(2-dimethylaminoethoxy)ethanol, 2-dimethylaminoethyl 3-dimethylaminopropyl ether, bis(2-dimethylaminoethyl) ether, N,N-dimethylpiperazine, N-(2-hydroxyethoxyethyl)-2-azanorborane, N,N,N′,N′-tetramethylbutane-1,3-diamine, N,N,N′,N′-tetramethylpropane-1,3-diamine or N,N,N′,N′-tetramethylhexane-1,6-diamine or any desired mixtures of two or more of said compounds.

The catalysts may also be present in an oligomerized or polymerized form, e.g. in the form of N-methylated polyethylenimine.

Suitable catalysts further include 1-methylimidazole, 2-methyl-1-vinylimidazole, 1-allylimidazole, 1-phenylimidazole, 1,2,4,5-tetramethylimidazole, 1-(3-aminopropyl)imidazole, pyrimidazole, 4-dimethylaminopyridine, 4-pyrrolidinopyridine, 4-morpholinopyridine, 4-methylpyridine or N-dodecyl-2-methylimidazole or any desired mixtures of two or more of the stated compounds.

Besides or instead of the tertiary amines it is also possible for organometallic compounds to be present in such moisture-curing PU sealants, such as organotin compounds of carboxylic acids, strong bases such as alkali metal hydroxides, alkali metal alkoxides and alkali metal phenoxides, e.g. di-n-octyltin mercaptide, dibutyltin maleate, diacetate, dilaurate, dichloride or bisdodecylmercaptide, tin(II) acetate, tin ethylhexoate and tin diethylhexoate or lead phenylethyldithiocarbamate.

As driers mention may be made in particular of alkoxysilyl compounds, such as vinyltrimethoxysilane, methyltrimethoxysilane, isobutyltrimethoxysilane, hexadecyltrimethoxysilane, and also inorganic substances, such as calcium oxide (CaO), for example, and compounds which carry isocyanate groups, such as tosyl isocyanate, for example. Adhesion promoters used are the known functional silanes, such as, for example, aminosilanes of the aforementioned kind, but also N-aminoethyl-3-aminopropyltrimethoxysilane, and/or N-aminoethyl-3-aminopropylmethyldimethoxysilane, epoxysilanes and/or mercaptosilanes.

Sealants, adhesives and coating materials based on the NCO-containing, moisture-curing prepolymers of the invention can be put to diverse uses. They are widely used for the coating, joining and sealing of materials made, for example, from metal, ceramic, glass, plastic, wood, concrete and other construction materials.

### EXAMPLES

Unless noted otherwise, all percentages are by weight.

The viscosities were determined at a measurement temperature of 23° C. with the aid of the Viscotester VT 550 rotational viscometer from Thermo Haake, Karlsruhe, DE, using the measuring cup SV and the SV DIN 2 measurement device.

The amount of free monomeric diisocyanate was determined by means of gel permeation chromatography (GPC). The measurement is carried out at room temperature. The eluent used is THF, the flow rate is 1 ml/min and the injection volume is 50 μl. Separating columns used are GPC columns packed with 5 μm separation material and having a porosity of 500 Å, such as are obtainable, for example, from MZ-Analysentechnik, Mainz, DE under the designation MZ-Gel SD-plus. The overall length of the separating columns is 120 cm. The detector used is a refractive index detector.

The NCO content of the prepolymers and reaction mixtures was determined in accordance with DIN EN 1242.

The Shore A hardnesses were determined in accordance with DIN 53505, tensile strength, breaking elongation and stress value in accordance with DIN 53504.

Polyether A:

Polyether polyol having a nominal functionality of 3 and a hydroxyl number of 35 mg KOH/g, prepared by propoxylating glycerol and then terminating it by ethoxylation. The ethylene oxide fraction is 13% by weight and the product contains 80-85 mol% of primary OH groups.

Polyether B:

Polyether polyol having a nominal functionality of 2 and a hydroxyl number of 28 mg KOH/g, prepared by propoxylating glycerol and then terminating it by ethoxylation. The ethylene oxide fraction is 13% by weight and the product contains 70-80 mol% of primary OH groups.

Polyether C:

Polypropylene glycol prepared via DMC catalysis in accordance with the Impact® process and having a nominal functionality of 2 and a hydroxyl number of 28 mg KOH/g (Acclaim® 4200 from Bayer MaterialScience AG, Leverkusen, DE).

Polyether D:

Polypropylene glycol prepared via DMC catalysis in accordance with the Impact® process and having a nominal functionality of 3 and a hydroxyl number of 28 mg KOH/g (Acclaim® 6300 from Bayer MaterialScience AG, Leverkusen, DE).

Polyether E:

Polyether polyol having a nominal functionality of 2 and a hydroxyl number of 260 mg KOH/g, prepared by propoxylating propylene glycol.

Polyether F:

Polyether polyol having a nominal functionality of 2 and a hydroxyl number of 147 mg KOH/g, prepared by propoxylating propylene glycol.

Diisocyanate I:

Desmodur® 44M (4,4′-diphenylmethane diisocyanate), Bayer MaterialScience AG, Leverkusen, DE

Diisocyanate II:

Diphenylmethane diisocyanate with the following isomer distribution:
2,4′-diphenylmethane diisocyanate=99.10%
4,4′-diphenylmethane diisocyanate=0.88%
2,2′-diphenylmethane diisocyanate=0.02%

Diisocyanate III:

Diphenylmethane diisocyanate with the following isomer distribution:
2,4′-diphenylmethane diisocyanate=96.93%
4,4′-diphenylmethane diisocyanate=3.05%
2,2′-diphenylmethane diisocyanate=0.02%

Diisocyanate IV:

Diphenylmethane diisocyanate with the following isomer distribution:
2,4′-diphenylmethane diisocyanate=99.92%
4,4′-diphenylmethane diisocyanate=0.04%
2,2′-diphenylmethane diisocyanate=0.04%

Mesamoll®: Plasticizer based on an alkylsulphonic ester of phenol, Bayer MaterialScience AG, Leverkusen, DE

DBTL:

Dibutyltin dilaurate, Goldschmidt TIB GmbH, Mannheim, DE under the name Tegokat® 218.

### Example 1

In a heatable and coolable glass flask provided with a stirrer mechanism and a dropping funnel, 266.73 g (1.07 mol) of diisocyanate II were melted at a temperature of 85° C. The melted diisocyanate was admixed with stirring first with 0.157 g of benzoyl chloride and then with a mixture, dewatered beforehand at a temperature of 100° C. under a vacuum of 15 mbar, of 1160.25 g (0.29 mol) of polyether B and 556.87 g (0.116 mol) of polyether A, at a rate such that the temperature of 85° C. remained constant. Thereafter the reaction mixture was stirred further at 85° C. until, after a reaction time of 12 hours, a constant NCO content of 2.51% (theoretical: 2.56%) was reached. Thereafter the temperature was lowered to 50° C. and 15.99 g of toluenesulphonyl isocyanate were added, after which the mixture was stirred for 15 minutes more and then the product discharged. The end product had an NCO content of 2.52%.

### Example 2

In a heatable and coolable glass flask provided with a stirrer mechanism and a dropping funnel, 298.75 g (1.195 mol) of diisocyanate II were melted at a temperature of 50° C. The melted diisocyanate was admixed with stirring first with 0.12 g of benzoyl chloride and then with dewatered beforehand at a temperature of 100° C. under a vacuum of 15 mbar, 1687.85 g (0.352 mol) of polyether A, at a rate such that the temperature of 50° C. remained constant. After the complete addition of the polyether the reaction mixture is heated at 70° C. and stirred further at this temperature until, after a reaction time of 19 hours, a constant NCO content of 2.81% (theoretical: 2.83%) was reached. Thereafter the temperature was lowered to 60° C. and first 13.27 g of toluenesulphonyl isocyanate and then 497.89 g of Mesamoll® were added, after which the mixture was stirred for 15 minutes more and then the product discharged. The end product had an NCO content of 2.24%.

### Example 3

In a heatable and coolable glass flask provided with a stirrer mechanism and a dropping funnel, 181.94 g (0.728 mol) of diisocyanate II were melted at a temperature of 50° C. The melted diisocyanate was admixed with stirring with a mixture, dewatered beforehand at a temperature of 100° C. under a vacuum of 15 mbar, of 659 g (0.165 mol) of polyether C and 659 g (0.11 mol) of polyether D, at a rate such that the temperature of 50° C. remained constant. Following the complete addition of the polyether mixture the reaction mixture was heated to 70° C. and stirred further at this temperature until, after a reaction time of 20 hours, a constant NCO content of 2.27% (theoretical: 2.24%) was reached. Thereafter the temperature was lowered to 60° C. and 10 g of toluenesulphonyl isocyanate were added, after which the mixture was stirred for 15 minutes more and then the product discharged. The end product had an NCO content of 2.20%.

### Example 4

In a heatable and coolable glass flask provided with a stirrer mechanism and a dropping funnel, 151.08 g (0.604 mol) of diisocyanate III were melted at a temperature of 50° C. The melted diisocyanate was admixed with stirring first with 0.15 g of DBTL and then with a mixture, dewatered beforehand at a temperature of 100° C. under a vacuum of 15 mbar, of 674.5 g (0.169 mol) of polyether C and 674.5 g (0.112 mol) of polyether D, at a rate such that the temperature of 50° C. does not rise. After the complete addition of the polyether mixture the reaction mixture is heated to 70° C. and stirred further at this temperature until, after a reaction time of 5 hours, a constant NCO content of 1.44% (theoretical: 1.50%) is reached. Thereafter the temperature is lowered to 60° C. and the catalyst is deactivated by adding 120 ppm of benzoyl chloride. Thereafter 12 g of toluenesulphonyl isocyanate are added, after which the mixture is stirred for 15 minutes more and then the product discharged. The end product has an NCO content of 1.50%.

### Example 5

In a heatable and coolable glass flask provided with a stirrer mechanism and a dropping funnel, 202.25 g (0.809 mol) of diisocyanate IV were melted at a temperature of 50° C.

The melted diisocyanate was admixed with stirring first with 0.2 g of DBTL and then with, dewatered beforehand at a temperature 100° C. under a vacuum of 15 mbar, 1797.75 g (0.3 mol) of polyether D, at a rate such that the temperature of 50° C. remained constant. After the complete addition of the polyether the reaction mixture was heated to 70° C. and stirred further at this temperature until, after a reaction time of 3 hours, a constant NCO content of 1.49% (theoretical: 1.51%) was reached. Thereafter the temperature was lowered to 60° C. and the catalyst is deactivated by adding 120 ppm of benzoyl chloride. Thereafter 15.76 g of toluenesulphonyl isocyanate are added, after which the mixture was stirred for 15 minutes more and then the product discharged. The end product had an NCO content of 1.49%.

### Example 6

Preparation of a Sealant Prepolymer in a Two-Stage Operation.

1st Stage: Preparation of an NCO-Functional Precursor:

In a heatable and coolable glass flask provided with a stirrer mechanism and a dropping funnel, 395 g (1.58 mol) of diisocyanate IV were melted at a temperature of 50° C. The melted diisocyanate was admixed with stirring first with 0.14 g of DBTL and then with, dewatered beforehand at a temperature 100° C. under a vacuum of 15 mbar, 1000 g (0.25 mol) of polyether C, at a rate such that the temperature of 50° C. remained constant. After the complete addition of the polyether mixture the reaction mixture was heated to 70° C. and stirred further at this temperature until, after a reaction time of 4 hours, a constant NCO content of 7.58% (theoretical: 8.0%) was reached. Thereafter the precursor was cooled to room temperature and discharged.

2nd stage: Preparation of a Sealant Prepolymer Using the Precursor Prepared Beforehand:

A heatable and coolable glass flask provided with a stirrer mechanism and a dropping funnel was charged at a temperature of 50° C. with 712.9 g of the precursor prepared in the first stage. Added thereto with stirring were first 0.13 g of DBTL and then a mixture, dewatered beforehand at a temperature of 100° C. under a vacuum of 15 mbar, of 387.7 g (0.097 mol) of polyether C and 899.4 g (0.15 mol) of polyether D, at a rate such that the temperature of 50° C. does not rise. After the complete addition of the polyether mixture the reaction mixture is heated to 70° C. and stirred further at this temperature until, after a reaction time of 3.5 hours, a constant NCO content of 1.26% (theoretical: 1.50%) is achieved. Thereafter the temperature is lowered to 60° C., the catalyst is deactivated by adding 240 ppm of benzoyl chloride and the product is then discharged. The end product has an NCO content of 1.26%.

### Comparative Example 1

In a heatable and coolable glass flask provided with a stirrer mechanism and a dropping funnel, 133.37 g (0.533 mol) of diisocyanate I were melted at a temperature of 85° C. The melted diisocyanate was admixed with stirring first with 0.075 g of benzoyl chloride and then with a mixture, dewatered beforehand at a temperature of 100° C. under a vacuum of 15 mbar, 580.13 g (0.145 mol) of polyether B and 278.44 g (0.058 mol) of polyether A, at a rate such that the temperature of 85° C. remained constant. Thereafter the reaction mixture was stirred further at 85° C. until, after a reaction time of 8 hours, a constant NCO content of 2.48% (theoretical: 2.56%) was reached. Thereafter the temperature was lowered to 50° C. and 8 g of toluenesulphonyl isocyanate were added, after which the mixture was stirred for 15 minutes more and then the product discharged. The end product had an NCO content of 2.48%.

### Comparative Example 2

In a heatable and coolable glass flask provided with a stirrer mechanism and a dropping funnel, 149.75 g (0.599 mol) of diisocyanate I were melted at a temperature of 50° C. The melted diisocyanate was admixed with stirring first with 0.06 g of benzoyl chloride and then with dewatered beforehand at a temperature of 100° C. under a vacuum of 15 mbar, 843.93 g (0.176 mol) of polyether A, at a rate such that the temperature of 50° C. remained constant. After the complete addition of the polyether the reaction mixture is heated at 70° C. and stirred further at this temperature until, after a reaction time of 14 hours, a constant NCO content of 2.84% (theoretical: 2.83%) was reached. Thereafter the temperature was lowered to 60° C. and first 6.64 g of toluenesulphonyl isocyanate and then 248.95 g of Mesamoll® were added, after which the mixture was stirred for 15 minutes more and then the product discharged. The end product had an NCO content of 2.24%.

### Comparative Example 3

In a heatable and coolable glass flask provided with a stirrer mechanism and a dropping funnel, 181.94 g (0.728 mol) of diisocyanate I were melted at a temperature of 50° C. The melted diisocyanate was admixed with stirring with a mixture, dewatered beforehand at a temperature of 100° C. under a vacuum of 15 mbar, of 659 g (0.165 mol) of polyether C and 659 g (0.11 mol) of polyether D, at a rate such that the temperature of 50° C. remained constant. Following the complete addition of the polyether mixture the reaction mixture was heated to 70° C. and stirred further at this temperature until, after a reaction time of 15 hours, a constant NCO content of 2.24% (theoretical: 2.24%) was reached. Thereafter the temperature was lowered to 60° C. and then first 10 g of toluenesulphonyl isocyanate and then 377.5 g of Mesamoll® were added, after which the mixture was stirred for 15 minutes more and then the product discharged. The end product had an NCO content of 1.86%.

### Comparative Example 4

In a heatable and coolable glass flask provided with a stirrer mechanism and a dropping funnel, 40.29 g (0.161 mol) of diisocyanate I were melted at a temperature of 50° C. The melted diisocyanate was admixed with stirring first with 4 mg of DBTL and then with a mixture, dewatered beforehand at a temperature of 100° C. under a vacuum of 15 mbar, of 179.86 g (0.045 mol) of polyether C and 179.86 g (0.03 mol) of polyether D, at a rate such that the temperature of 50° C. does not rise. After the complete addition of the polyether mixture the reaction mixture was heated to 70° C. and stirred further at this temperature until, after a reaction time of 2 hours, a constant NCO content of 1.41% (theoretical: 1.50%) was reached. Thereafter the temperature was lowered to 60° C. and the catalyst is deactivated by adding 120 ppm of benzoyl chloride. Thereafter 3.04 g of toluenesulphonyl isocyanate are added, after which the mixture was stirred for 15 minutes more and then the product discharged. The end product had an NCO content of 1.41%.

### Comparative Example 5

In a heatable and coolable glass flask provided with a stirrer mechanism and a dropping funnel, 40.29 g (0.161 mol) of diisocyanate I were melted at a temperature of 50° C. The melted diisocyanate was admixed with stirring with a mixture, dewatered beforehand at a temperature of 100° C. under a vacuum of 15 mbar, of 179.86 g (0.045 mol) of polyether C and 179.86 g (0.03 mol) of polyether D, at a rate such that the temperature of 50° C. does not rise. After the complete addition of the polyether mixture the reaction mixture was heated to 70° C. and stirred further at this temperature until, after a reaction time of 28 hours, a constant NCO content of 1.52% (theoretical: 1.50%) was reached. Thereafter the temperature was lowered to 60° C. and 2.64 g of toluenesulphonyl isocyanate are added, after which the mixture was stirred for 15 minutes more and then the product discharged. The end product had an NCO content of 1.52%.

### Comparative Example 6

In a heatable and coolable glass flask provided with a stirrer mechanism and a dropping funnel, 101.7 g (0.407 mol) of diisocyanate IV were melted at a temperature of 70° C. The melted diisocyanate was admixed with stirring first with 22 mg of DBTL and then with a mixture, dewatered beforehand at a temperature of 100° C. under a vacuum of 15 mbar, of 94.64 g (0.22 mol) of polyether E and 23.66 g (0.0039 mol) of polyether D, at a rate such that the temperature of 70° C. does not rise. After the complete addition of the polyether mixture the reaction mixture was stirred further at this temperature until, after a reaction time of 4.5 hours, a constant NCO content of 6.7% (theoretical: 6.9%) was reached. Thereafter the temperature was lowered to 60° C. and the catalyst is deactivated by adding 33 ppm of benzoyl chloride and the product is then discharged. The end product had an NCO content of 6.7%.

### Comparative Example 7

In a heatable and coolable glass flask provided with a stirrer mechanism and a dropping funnel, 490.09 g (1.96 mol) of diisocyanate IV were melted at a temperature of 70° C. The melted diisocyanate was admixed with stirring first with 0.15 g of DBTL and then with a mixture, dewatered beforehand at a temperature of 100° C. under a vacuum of 15 mbar, of 807.95 g (1.105 mol) of polyether F and 201.95 g (0.034 mol) of polyether D, at a rate such that the temperature of 70° C. does not rise. After the complete addition of the polyether mixture the reaction mixture was stirred further at this temperature until, after a reaction time of 4.5 hours, a constant NCO content of 4.74% (theoretical: 4.87%) was reached. Thereafter the temperature was lowered to 60° C. and the catalyst is deactivated by adding 120 ppm of benzoyl chloride and the product is then discharged. The end product had an NCO content of 4.74%.

### Comparative Example 8

In a heatable and coolable glass flask provided with a stirrer mechanism and a dropping funnel, 197.5 g (0.79 mol) of diisocyanate II were melted at a temperature of 50° C. The melted diisocyanate was admixed with stirring with a mixture, dewatered beforehand at a temperature of 100° C. under a vacuum of 15 mbar, of 1042 g (0.261 mol) of polyether C and 260.5 g (0.0434 mol) of polyether D, at a rate such that the temperature of 50° C. remained constant. After the complete addition of the polyether mixture the reaction mixture was heated to 70° C. and stirred further at this temperature until, after a reaction time of 20 hours, a constant NCO content of 2.57% (theoretical: 2.61%) was reached. Thereafter the temperature was lowered to 60° C. and 12 g of toluenesulphonyl isocyanate are added, after which the mixture was stirred for 15 minutes more and then the product discharged. The end product had an NCO content of 2.60%.

Production of Specimens for Determining the Mechanical Properties:

In a cross-arm kneading apparatus 240 g of Mesamoll®, 405 g of Omya BLP 3 (calcium carbonate (filler), Omya GmbH, Cologne, DE) and 170 g of binder from the corresponding examples were kneaded with 21 g of Desmodur® VH 20 (polyisocyanate semiprepolymer based on MDI, Bayer MaterialScience AG, Leverkusen, DE) and 45 g of Wacker HDK N 20 (pyrogenic silica, Wacker Chemie GmbH, Munich, DE) under a dynamic vacuum for 30 minutes. Subsequently a further 100 g of the respective binder, 5.4 g of Dynasylan GLYMO (glycidyl 3-(trimethoxysilyl)propyl ether, Degussa AG, Frankfurt am Main, DE) and 2.7 g of Dabco T-12N (dibutyltin dilaurate, Air Products, 3502 GD Utrecht, NL) were added. The mixture was kneaded under a static vacuum for 20 minutes and then deaerated by brief application of a dynamic vacuum. The resulting mixtures were dispensed into aluminium cartridges and processed the next day to membranes approximately 2 mm thick. The membranes were subsequently cured at room temperature for 14 days.

Discussion of the Results:

As is apparent from the results summarized in Tables 1 and 2, the prepolymers prepared on the basis of pure 2,4′-MDI (Examples 1, 2 and 3) have a viscosity reduced by about half as compared with the products based on 4,4′-MDI (Desmodur® 44 M) (Comparative Examples 1, 2 and 3). In relation to the comparison it should be borne in mind that Example 3 differs from Comparative Example 3 in containing no Mesamoll. At the same time there was only a slight change in the mechanical properties of the sealants produced using the different prepolymers. Thus the 2,4′-MDI-based sealants have a slightly higher breaking elongation in conjunction with a comparable stress value (100% modulus) and comparable Shore A hardness.

If an NCO/OH equivalent ratio <2.0 is chosen and if additionally DBTL, for example, is employed as catalyst during the preparation of the prepolymer (Example 4), the result is an NCO-containing prepolymer which in comparison to the product based on 4,4′-MDI (Desmodur® 44 M) (Comparative Examples 4 and 5) not only has a drastically reduced viscosity (factor of 20 and 3, respectively) but also has a residual monomer content <0.3%. With a prepolymer of this kind it is possible to produce moisture-curing sealants which require no labelling, having residual monomer contents <0. 1%. The mechanical properties of these sealants are at a similar level to those of Example 3, whose prepolymer was prepared with the same polyol mixture but with an NCO/OH equivalent ratio >2.0 and without DBTL catalysis, and therefore has a residual monomer content well above 0.3%.

Where the prepolymers are prepared using polyol mixtures composed of more than 70% of short-chain polyethers (molar masses <1000 g/mol), products are obtained which either are solid at room temperature (Comparative Example 6) or have very high viscosities (Comparative Example 7) in comparison to the products of the invention. Additionally the amounts of free monomeric MDI, with a NCO/OH ratio of 1.8 and with DBTL catalysis, are significantly greater than 0.3% by weight, whereas in the case of the products of the invention, with the same NCO/OH ratio and with DBTL catalysis, residual monomer contents <0.3% by weight result. The mechanical properties of the sealant produced with the prepolymer from Comparative Example 7, as well, are unsatisfactory. The Shore A hardness is much too high as compared with the sealants produced from the prepolymers of the invention, while the breaking elongation, at only 21%, is completely inadequate for a sealant (the sealants of the invention have breaking elongations of between about 330% and about 530%). Moreover, the sealant produced from Comparative Example 7 exhibits severe exudation of the plasticizer present in the sealant formulation, thereby giving a very tacky product. The sealants produced from the prepolymers of the invention, by contrast, display no plasticizer exudation. These products are completely tack-free after 1 to 7 days. The fact that the poor mechanical properties of the sealant produced from Comparative Example 7 are attributable not to the high fraction of trifunctional polyether but rather to the high fraction of hard segment (caused by the low molecular weight polyether) is shown by the Inventive Example 5, which is based exclusively on a trifunctional polyether. With the prepolymer from Example 5 it is possible to formulate sealants having good mechanical properties. Prepolymers prepared using polyol mixtures composed of more than 70% by weight of short-chain polyethers (molar masses <1000 g/mol) are therefore unsuitable for the formulation of sealants. With a fraction of less than 20% by weight of the trifunctional polyether in the polyol mixture (Comparative Example 8) there is a deterioration in mechanical properties, and so a fraction of polyethers of higher functionality (functionality >2) of >20% is advatageous.

TABLE 1
Viscosity comparisons at 23° C. in mPa · s

| | | | Residual monomer |
|---|---|---|---|
| Binder | Viscosity | | content |
| Example 1 | 9 740 | mPa · s | 3.1% by weight |
| Example 2 | 9 785 | mPa · s | 2.7% by weight |
| Example 3 | 14 225 | mPa · s | 2.1% by weight |
| Example 4 | 4 800 | mPa · s | 0.1% by weight |
| Example 5 | 66 300 | mPa · s | <0.1% by weight |
| Example 6, 1^{st} stage | 3 410 | mPa · s | 17.6% by weight |
| Example 6, 2nd stage | 66 500 | mPa · s | <0.1% by weight |
| Comparative Example 1 | 23 600 | mPa · s | 3.7% by weight |
| Comparative Example 2 | 23 650 | mPa · s | 3.1% by weight |
| Comparative Example 3 | 38 200 | mPa · s | Not determined |
| (before adding Mesamoll) | | | |
| Comparative Example 3 | 18 525 | mPa · s | 2.3% by weight |
| (after adding Mesamoll) | | | |
| Comparative Example 4 | 96 000 | mPa · s | 1.4% by weight |
| Comparative Example 5 | 76 800 | mPa · s | 1.4% by weight |
| | not measurable | | |
| Comparative Example 6 | (>>10⁶ | mPa · s) | 0.8% by weight |
| Comparative Example 7 | 135 000 | mPa · s | 0.5% by weight |
| Comparative Example 8 | 11 300 | mPa · s | 2.6% by weight |

TABLE 2
Comparison of mechanical properties

| Formulation | | Tensile | Breaking elonga- | Stress |
|---|---|---|---|---|
| based | | strength | tion | value 100% |
| on: | Shore A | [N/mm²] | [%] | [N/mm²] |
| Example 1 | 42 | 1.4 | 533 | 0.8 |
| Example 2 | 54 | 2.7 | 343 | 1.2 |
| Example 3 | 53 | 2.6 | 646 | 1.2 |
| Example 4 | 49 | 2.3 | 610 | 1.1 |
| Example 5 | 56 | 2.8 | 330 | 1.2 |
| Example 6, | 52 | 3.7 | 606 | 1.0 |
| 2nd stage | | | | |
| Comp. Ex. 1 | 45 | 1.2 | 458 | 0.8 |
| Comp. Ex. 2 | 54 | 2.1 | 248 | 1.2 |
| Comp. Ex. 3 | 51 | 3.5 | 626 | 1.1 |
| Comp. Ex. 7 | 82 | 2.5 | 21 | not measurable |
| Comp. Ex. 8 | 53 | 1.2 | 70 | not measurable |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing MDI-based prepolymers which are free of carboxylic ester groups and have shear viscosities of <100 000 mPa.s at 23° C., wherein
A) an isocyanate which is an MDI type containing at least 95% by weight of 2,4′-MDI is reacted with
B) a polyether polyol mixture composed of
b1) at least one polyether polyol with a number-average molecular weight Mₙ of 2000 to 20000 g/mol and an average OH functionality of 3 to 8 and
b2) optionally, one or more polyether polyols having number-average molecular weights of more than 2000 g/mol
and wherein the fraction of b1) in B) is at least 20% by weight and B) is composed of b1) and b2) in such a way as to result in an overall functionality, relative to OH groups, of >2 and a number-average molecular weight Mₙ of from 3000 to 20000 g/mol.

2. Process for preparing MDI-based prepolymers free from carboxylic ester groups according to claim 1, wherein the NCO/OH ratio is 1.4-1.9.

3. Process for preparing MDI-based prepolymers free from carboxylic ester groups according to claim 1, wherein the isocyanate used in A) has a 2,4′-MDI content of at least 97.5% by weight and a 2,2′-MDI content of not more than 0.25% by weight.

4. Process for preparing MDI-based prepolymers free from carboxylic ester groups according to claim 1, wherein in b1) said at least one polyether polyol has a number-average molecular weight of 2000 to 15000 g/mol and an average OH functionality of 3 to 4.

5. Process for preparing MDI-based prepolymers free from carboxylic ester groups according to claim 1, wherein in b2) said one or more polyether polyols has a number-average molecular weight of 2000 to 18000 g/mol.

6. Process for preparing MDI-based prepolymers free from carboxylic ester groups according to claim 1, wherein in b1) and b2) said polyether polyol has an ethylene oxide fraction of 0% to 15% by weight.

7. Process for preparing MDI-based prepolymers free from carboxylic ester groups according to claim 1, wherein the fraction of component b1) in the total polyether polyol mixture B) is at least 30% by weight.

8. MDI-based prepolymers free from carboxylic ester groups, obtainable by a process according to claim 1.

9. MDI-based prepolymers free from carboxylic ester groups, according to claim 8, in solvent-free form they have residual methylenediphenyl diisocyanate contents of less than 0.15% by weight and shear viscosities of 5000-70000 mPa.s at 23° C.

10. A moisture-curing adhesive or sealant comprising the MDI-based prepolymers made by the process of claim 1.

11. A moisture-curing adhesive or sealant comprising the MDI-based prepolymers according to claim 7.
